(19) United States
(12) Patent Application Publication
(10) Pub. No.: US 2007/0291504 A1
(43) Pub. Date: Dec. 20, 2007

(54) FUSED FIBER ARRAY OPTICS FOR LED

(76) Inventor: Chun-I Lu, Taipei (TW)

Correspondence Address: LEONG C LEI, PMB # 1008, 1867 YGNACIO VALLEY ROAD, WALNUT CREEK, CA, 94598, US

(21) Appl. No.: 11/425,146

(22) Filed: Jun. 20, 2006

(51) Int. Cl. G02B 6/00

(52) U.S. Cl. 362/551

(57) ABSTRACT

A fused fiber array optics is provided as a LED lens. The fused fiber array optics is formed by multiple fibers having a same numerical aperture arranged and fused together. Each fiber has a transparent core wrapped inside a cladding. By choosing fibers of a particular numerical aperture and using the resultant fused fiber array optics as the lens of a LED device, the manufacturer of the LED device can achieve a desired illuminating range from the LED device.

### BACKGROUND OF THE INVENTION

(a) Technical Field of the Invention

The present invention generally relates to light emitting diodes (LEDs), and more particularly to a fused fiber array optics for LEDs.

(b) Description of the Prior Art

As shown in FIG. 16, a conventional LED device has a lighting element 21 (e.g., a GaN-based LED chip) placed on top of a base 20. The Lighting element 21 is sealed inside a plastic lens 22 for light projection.

After a period of usage, the aged and mat plastic lens 22 would have a degraded transmittance, significantly reducing the brightness of the LED device.

On the other hand, the plastic lens 22 would refract the light emitted from the Lighting element 21, causing a halo effect and reducing the illumination performance of the LED device.

A number of improved LED lenses have been proposed. For example, in R.O.C. (Taiwan) Patent No. M245555, a LED lamp is disclosed which contains multiple LED chips and a disc-like lens. The disc-like lens contains multiple densely arranged lens units, each of which is positioned correspondingly to one of LED chips. Each lens unit has a curved surface functioning as a convex lens. The other surface of the lens unit has multiple orthogonal ripples. As such, each lens unit provides both focusing (by the convex lens) and diffusing (by the orthogonal ripples) to enhance the brightness and uniformity of the light emitted from the corresponding LED chip. However, if the disc-like lens is made of plastic, the aforementioned problems of degraded transmittance and undesireable halo effect are still inevitable.

If the disc-like lens is made of glass, then, forming ripples would be quite difficult, thereby causing a much higher production cost.

### SUMMARY OF THE INVENTION

The primary purpose of the present invention is to provide a fused fiber array optics so as to obviate the foregoing shortcomings of conventional LED lenses. The fused fiber array optics of the present invention if formed by multiple fibers having a same numerical aperture arranged and fused together. Each fiber has a transparent core inside and wrapped an outer shell cladding, and the fibers diameter may all the same or have the different size.

The fibers can be arranged in various manners to form an appropriate cross-sectional shape. For example, the bundle of the fibers can be arranged to have a circular, hexagonal, octagonal cross-section. The fibers can also fan out from the axis of the fused fiber array optics like a cone.

Each of the cores can be made of transparent glass of an appropriate color. The cross-section of each core can be circular, hexagonal, or any other appropriate shape such as oval.

The present invention has a number of advantages. First, as each fiber can deliver light independently, the brightness of the LED device is much enhanced in comparison to the conventional LED device using plastic lens. Secondly, the production of the present invention is quite simple. The fused fiber array optics is formed by fusion a bundle of glass fibers array together under high temperature in vacuum. The fused fiber optics array is then obtained by slicing the fiber bundle into a thin piece whose two surfaces can be further grinded into concave or convex ones so as to further adjust the illuminating range of the LED device. As the fibers are made of glass, the present invention is much more robust than the plastic lenses of prior arts in terms of aging and degraded transmittance. The present invention therefore has a prolonged operation life. As the fused fiber array optics of the present invention is formed into a thin piece, the LED device having the fiber array as lens is much lower in height in comparison to the conventional LED device.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many advantages and features of the present invention will become manifest to those versed in the art upon making reference to the detailed description and the accompanying sheets of the drawings in which a preferred structural embodiment incorporating the principles of the present invention is shown by way of illustrating example.

### BRIEF DESCRIPTION OF THE DRAWINGS

FIG. 1 is a cross-sectional diagram showing the fused fiber array optics according to the first embodiment of the present invention.

FIG. 2 is a perspective and cross-sectional diagram showing the fused fiber array optics of FIG. 1 applied to a LED device.

FIG. 3 is a profile diagram showing the illuminating ranges of the LED device of FIG.2 when fibers of a smaller aperture are used.

FIG. 4 is a profile diagram showing the illuminating range of the LED device of FIG. 2 when fibers of a larger aperture are used.

FIG. 5 is a cross-sectional diagram showing the fused fiber array optics according to the second embodiment of the present invention.

FIG. 6 is a cross-sectional diagram showing the fused fiber array optics according to the third embodiment of the present invention.

FIG. 7 is a profile diagram showing the illuminating range of the LED device of FIG. 2 when the fused fiber array optics is grinded into a convex lens.

FIG. 8 is a profile diagram showing the illuminating range of the LED device of FIG. 2 when the fused fiber array optics is grinded into a concave lens.

FIG. 9 is a profile diagram showing the illuminating range of the LED device of FIG.2 when the fused fiber array optics is arched.

FIG. 10 is a profile diagram showing the illuminating range of a LED device whose fibers fan out towards the base.

FIG. 11 is a profile diagram showing the illuminating range of the LED device of FIG. 10 when the fused fiber array optics is grinded into a convex lens.

FIG. 12 is a profile diagram showing the illuminating range of the LED device of FIG. 10 when the fused fiber array optics is grinded into a concave lens.

FIG. 13 is a profile diagram showing the illuminating range of a LED device whose fibers fan out away from the base.

FIG. 14 is a profile diagram showing the illuminating range of the LED device of FIG. 13 when the fused fiber array optics is grinded into a convex lens.

FIG.15 is a profile diagram showing the illuminating range of the LED device of FIG. 13 when the fused fiber array optics is grinded into a concave lens.

FIG. 16 is a perspective diagram showing a conventional LED device cut sectionally.

### DETAILED DESCRIPTION OF THE PREFERRED EMBODIMENTS

The following descriptions are of exemplary embodiments only, and are not intended to limit the scope, applicability or configurations of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

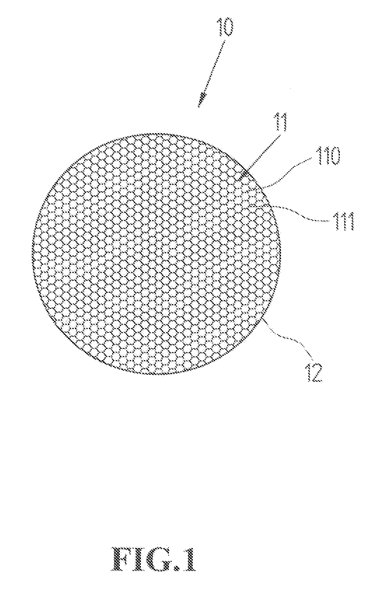

As shown in FIG. 1, a fused fiber array optics 10 according to an embodiment of the present invention is formed by arranging and fusing together multiple fibers 11. Each fiber contains a core 110 of a same numerical aperture, which in turn is surrounded by a cladding 111 having a different refractive index from that of the core 110. The cores 110 are made of transparent glass. The cross-section of each core 110 can be circular, hexagonal, polygonal, or oval. Each core 110 can also be made of a transparent glass of an appropriate color.

As shown in FIG. 1, the fibers 11 are arranged into a bundle so that the cross-section of the fused fiber array optics has a circular shape. The entire bundle of fibers 11 is wrapped inside in a cladding 12. The fibers 11 and the cladding 12 are then fused together under a high temperature in vacuum. The bundle of fibers 11 is sliced cross-sectionally so as to form the fused fiber array optics 10 of the present invention. The cladding 12 can be optionally grinded away after slicing.

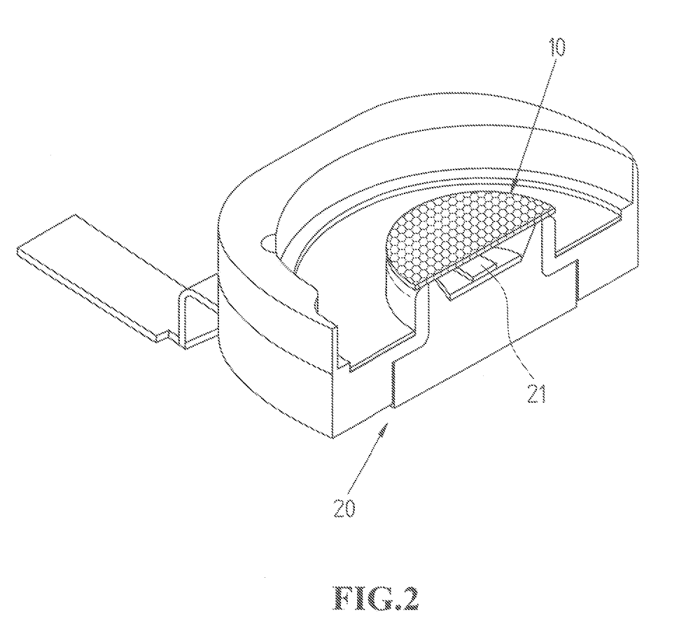

As shown in FIG. 2, the fused fiber array optics 10 is positioned on top of the base 20 to enclose the lighting element 21 inside the base 20. Determined by the numerical aperture of the cores 110 of the fibers 11, the fused fiber array optics 10 is able to limit the light emitting from the lighting unit 21 in a particular illuminating range.

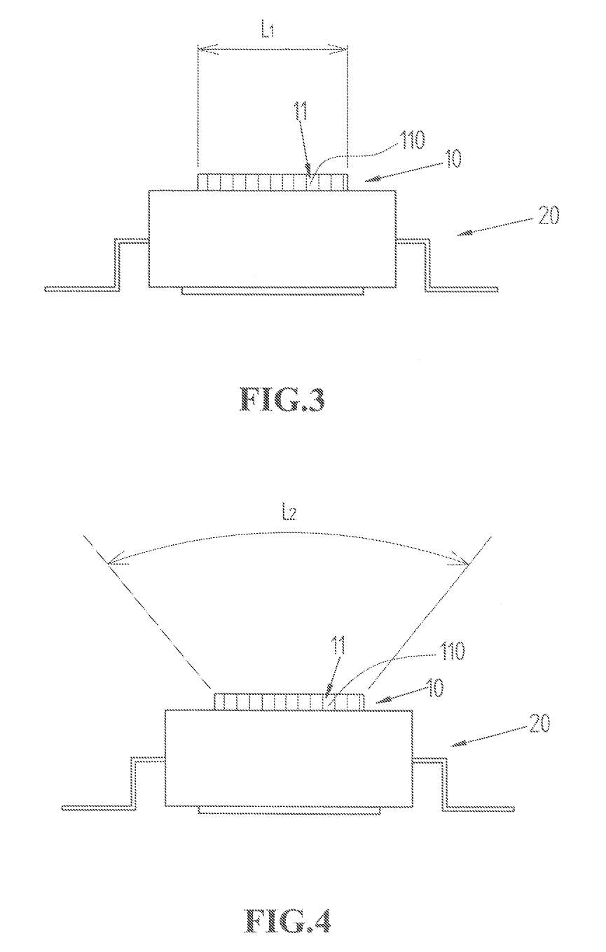

As shown in FIG. 3, if the numerical aperture of the cores 110 of the fibers 11 is 0.1, the light from the lighting element 21 would have a light emission angle of 11 degrees after passing through the fused fiber array optics 10, producing a narrow and nearly straight illuminating range L₁.

As shown in FIG. 4, if a numerical aperture of the cores 110 of the fibers 11 is 0.44, the light from the lighting element 21 would have a light emission angle of 52 degrees after passing through the fused fiber array optics 10, producing a wide and scattered illuminating range L₂. Accordingly, by choosing fibers 11 of a particular numerical aperture and using the resultant fused fiber array optics 10 as the lens of a LED device, the manufacturer of the LED device can achieve a desired illuminating range from the LED device.

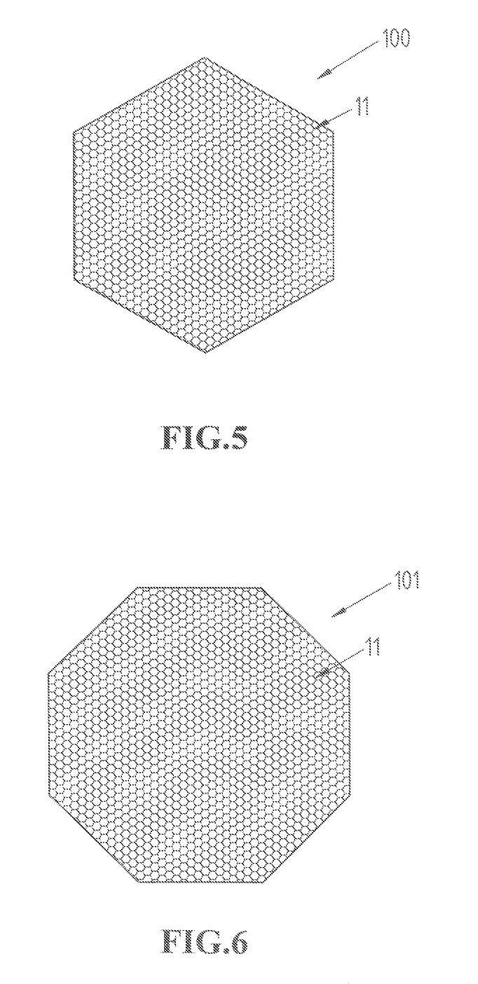

As shown in FIG. 5, the fibers 11 are arranged so as to form a fused fiber array optics having a hexagonal cross-section. Additionally, as shown in FIG. 6, the fibers 11 can also be arranged to form a fused fiber array optics 101 having an octagonal cross-section.

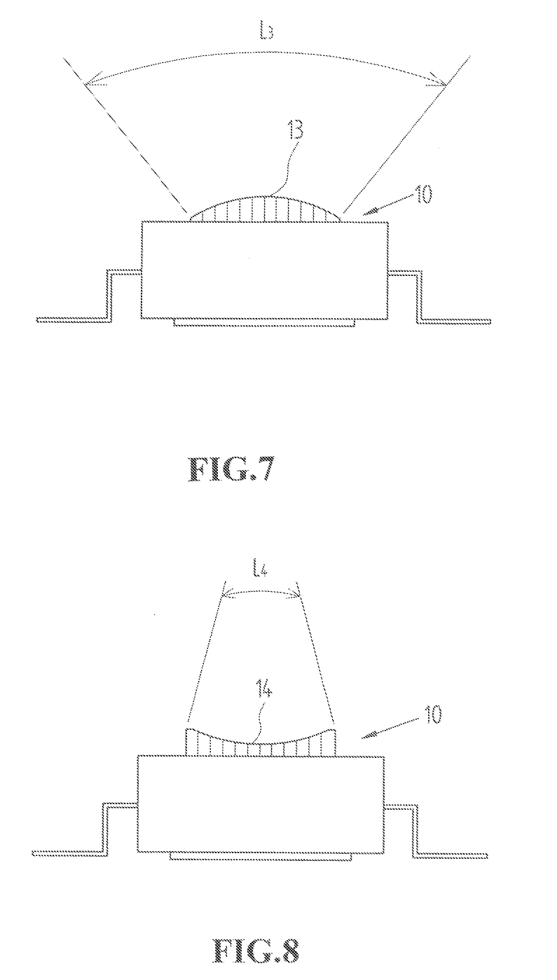

As illustrated in FIG. 7, the fused fiber array optics 10 can be grinded to have a curved outer surface 13. The fiber array 10 therefore would function like a convex lens to produce a wider illuminating range L₃.

In another embodiment depicted in FIG. 8, the fused fiber array optics 10 is grinded to have a sunken outer surface 14. The fused fiber array optics 10 therefore would function like a concave lens to produce a focused illuminating range L₄.

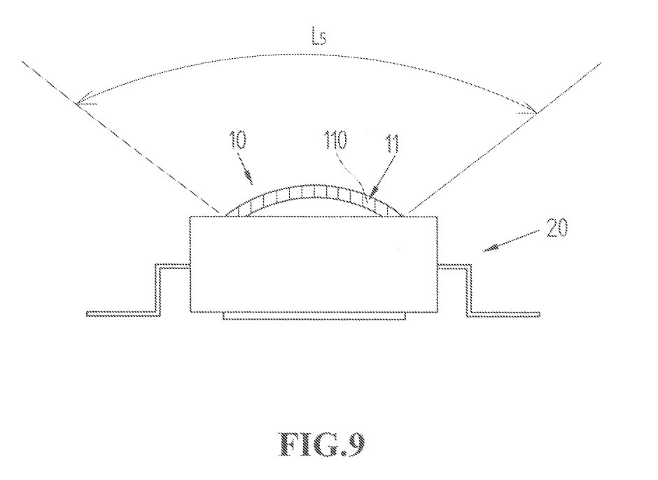

In yet another embodiment shown in FIG. 9, the fused fiber array optics 10 is arched by hot press during manufacture so that the fused fiber array optics 10 functions like a concave lens to produce an even wider illuminating range L₅.

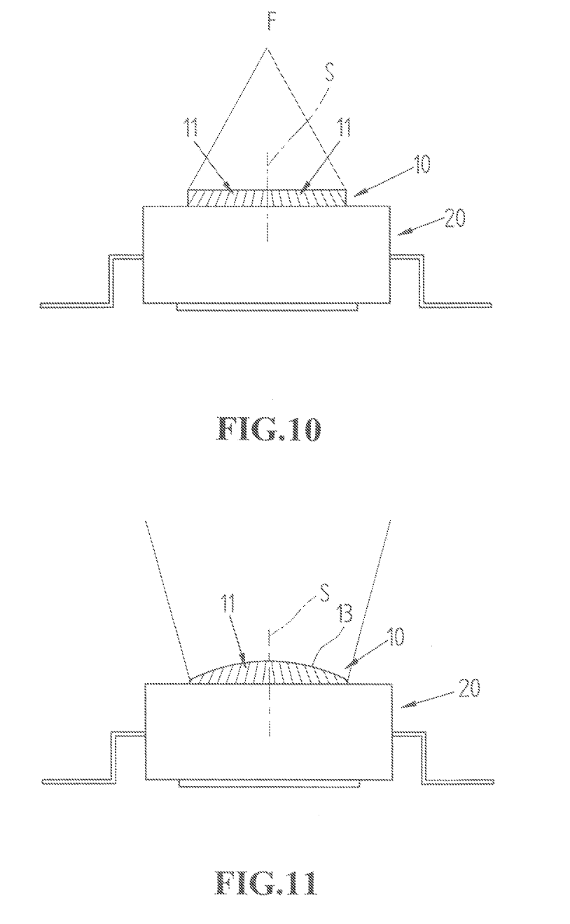

As shown in FIGS. 10 to 15, the fibers 11 of the fused fiber array optics 10 are configured to fan out from the axis S of the fused fiber array optics 10 like a cone when the fibers 11 are fused in vacuum.

As shown in FIG. 10, the fibers 11 fan out from the axis S towards the base 20. A such, the light passing through the fused fiber array optics 10 is directed and focused at a focus point F.

As shown in FIG. 11, the outer surface of the fused fiber array optics 10 of FIG. 10 is grinded into a bulging curved surface 13 so that the fused fiber array optics 10 functions like a concave lens.

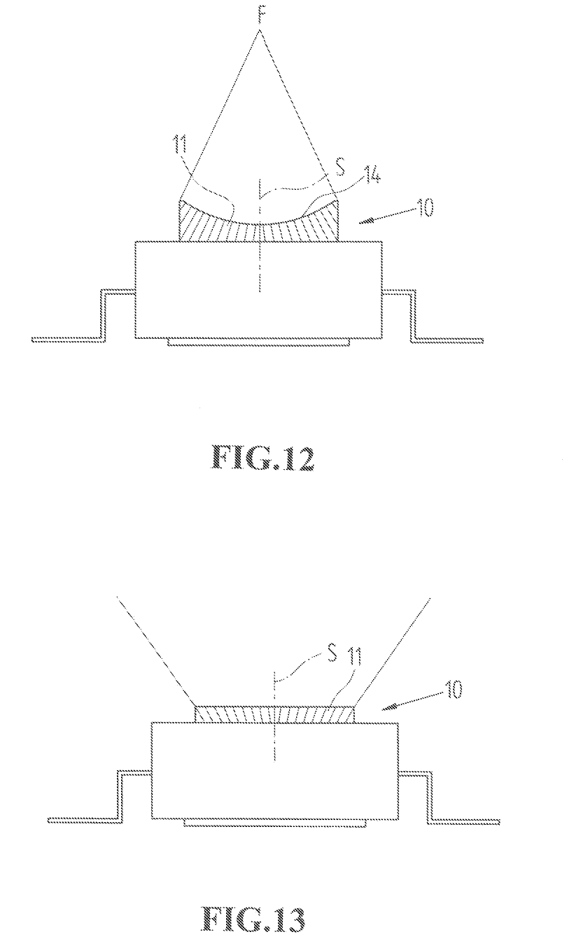

As shown in FIG. 12, the outer surface of the fused fiber array optics 10 of FIG. 10 is grinded into a sunken curved surface 14 so that the fused fiber array optics 10 functions like a concave lens.

In an alternative embodiment shown in FIG. 13, the fibers 11 fan out from the axis S away from the base 20. As such, the light passing through the fused fiber array optics 10 is further spread outward.

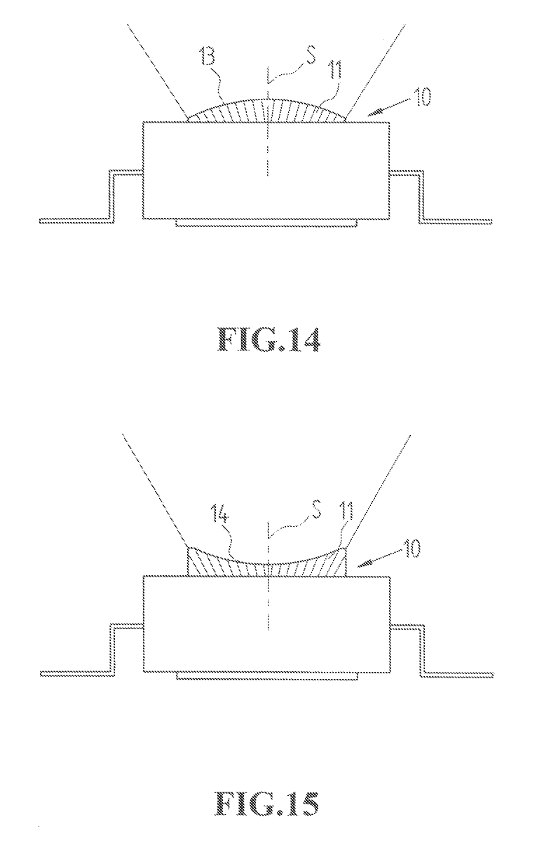

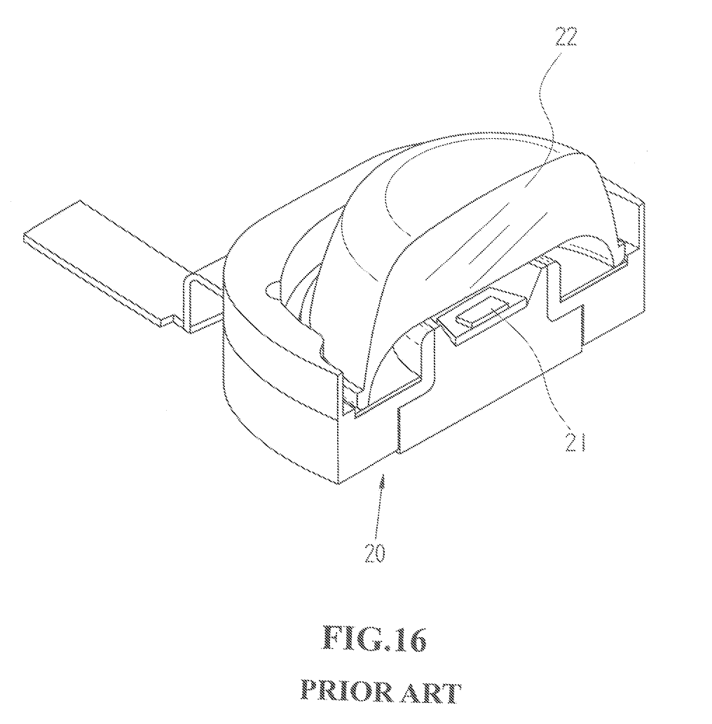

As shown in FIG. 14, the outer surface of the fused fiber array optics 10 of FIG. 13 is grinded into a bulging curved surface 13 so that the fused fiber array optics 10 functions like a convex lens. As shown in FIG. 15, the outer surface of the fused fiber array optics 10 of FIG. 13 is grinded into a sunken curved surface 14 so that the fused fiber array optics 10 functions like a concave lens.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fused fiber array optics as a lens positioned on the base a LED device, comprising:
a plurality of fibers having a same numerical aperture arranged and fused together, each of said fibers having a transparent core wrapped inside a cladding.

2. The fused fiber array optics according to claim 1, wherein said fibers are arranged so that said fiber array has one of a circular, hexagonal, and octagonal cross-sectional shape.

3. The fused fiber array optics according to claim 1, wherein each of said cores is made of colored and transparent glass.

4. The fused fiber array optics according to claim 1, wherein each of said cores has one of a circular, oval, hexagonal, and polygonal cross-section.

5. The fused fiber array optics according to claim 1, wherein said fibers fan out from the axis of said fiber array.

6. The fused fiber array optics according to claim 5, wherein said fibers fan out from the axis of said fiber array towards the base of said LED device.

7. The fused fiber array optics according to claim 5, wherein said fibers fan out from the axis of said fiber array away from the base of said LED device.

8. The fused fiber array optics according to claim 1, wherein the outer surface of said fused fiber array optics is a convex surface.

9. The fused fiber array optics according to claim 1, wherein the outer surface of said fused fiber array optics is a concave surface.

10. The fused fiber array optics according to claim 1, wherein said fused fiber array optics is arched.
